(19) United States
(12) Patent Application Publication
(10) Pub. No.: US 2025/0100541 A1
(43) Pub. Date: Mar. 27, 2025

(54) METHOD OF CONTROLLING REGENERATIVE BRAKING OF HYBRID VEHICLE AND SYSTEM THEREOF

(71) Applicants: Hyundai Motor Company, Seoul (KR); Kia Corporation, Seoul (KR)

(72) Inventor: Jeewook HUH, Seoul (KR)

(73) Assignees: Hyundai Motor Company, Seoul (KR); Kia Corporation, Seoul (KR)

(21) Appl. No.: 18/819,748

(22) Filed: Aug. 29, 2024

(30) Foreign Application Priority Data
Sep. 22, 2023 (KR) 10-2023-0127016
Jul. 2, 2024 (KR) 10-2024-0087082

(51) Int. Cl. B60W 20/15; B60W 10/02; B60W 10/08; B60W 10/18; B60W 30/18

(52) U.S. Cl. CPC B60W 20/15; B60W 10/02; B60W 10/08; B60W 10/18; B60W 30/18127; B60W 2510/244; B60W 2540/12

(57) ABSTRACT

A method of controlling regenerative braking of a dual-motor hybrid vehicle and a system thereof may include collecting driving information of the vehicle during an operation of the vehicle and starting braking when a brake pedal operation signal is input; determining, each of a first regenerative braking capacity using only a second motor and a second regenerative braking capacity using a first motor and the second motor in consideration of whether an engine clutch is engaged collected as the driving information, battery chargeable power, potential generation power of each of the first motor and the second motor based on the engine clutch, and engine friction force; and determining, whether to maintain engagement of the engine clutch by determining whether an regenerative braking capacity at the time of disengagement of the engine clutch determined in a state in which the engine clutch is engaged is less than a first reference value.

### CROSS-REFERENCE TO RELATED APPLICATION

The present application claims priority to Korean Patent Application No. 10-2023-0127016 filed on Sep. 22, 2023 and Korean Patent Application No. 10-2024-0087082 filed on Jul. 2, 2024, the entire contents of which is incorporated herein for all purposes by this reference.

### BACKGROUND OF THE PRESENT DISCLOSURE

### Field of the Present Disclosure

The present disclosure relates to regenerative braking control of a hybrid vehicle equipped with a dual motor, and more particularly, to a method of controlling regenerative braking of a Hybrid vehicle having the TMED II structure equipped with a first motor and a second motor at the front and rear of a clutch, and a system thereof.

### Description of Related Art

Hybrid electric vehicles (HEV/PHEV) use two or more power sources and mainly refer to electric vehicles driven by an engine and a motor.

FIG. 6 schematically illustrates a regenerative braking structure of the related art hybrid vehicle.

Referring to FIG. 6, the related art hybrid vehicle starts an engine and generates power through a hybrid starter generator (hereinafter, also referred to as “P0 motor”) connected by a belt and utilizes a transmission mounted electric device (TMED) (hereinafter, referred to as “TMED I”) type powertrain in which a drive motor (hereinafter, referred to as “P2 motor”), a transmission, and a wheel axle are connected in series. Furthermore, an engine clutch is provided between the engine and the P2 motor, and the vehicle operates in an electric vehicle (EV) mode or hybrid electric vehicle (HEV) mode depending on whether the engine clutch is engaged. The EV mode is a mode in which the vehicle is driven only by driving force of the P2 motor, and HEV mode is a mode in which the vehicle is driven by driving force of the P2 motor and the engine.

Recently, vehicle manufacturers have continued research and efforts to optimize motor installation locations which may secure performance while reducing motor capacity to improve the profitability of hybrid vehicles. As part thereof, a TMED II type powertrain structure (see FIG. 1) in which the HSG (P0 motor) is deleted from the related art TMED I structure and the P1 motor added to an output terminal of the engine, the engine clutch, the P2 motor, the transmission, and the wheel axle were connected in series has come to prominence.

Hybrid vehicles having the TMED II structure include a new structure in which the engine clutch is provided between the P1 motor on the engine side and the P2 motor on the transmission side and the vehicle operates in the EV mode or HEV mode depending on whether the engine clutch is engaged. Therefore, regenerative braking optimization is necessary to secure the performance and fuel efficiency of TMED II hybrid vehicles.

However, with the TMED II structure, regenerative braking of the P1 motor is difficult and regenerative braking is performed only with the P2 motor, so regenerative braking optimization cannot be controlled.

Furthermore, since there is no cooperative control logic dedicated to optimize regenerative braking of the P1 and P2 motors, fuel efficiency deteriorates due to the inability to control an optimal operating point.

The information included in this Background in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method of controlling regenerative braking of a hybrid vehicle provided with dual motors and a system thereof configured for improving vehicle performance and fuel efficiency by preferentially controlling sole regenerative braking using a second motor P2 according to disengagement of an engine clutch according to a regenerative braking demand and providing cooperative regenerative braking control logic additionally using a first motor P1 through engagement of an engine clutch considering loss due to engine friction force when the regenerative braking demand increases.

According to an exemplary embodiment of the present disclosure, a method of controlling regenerative braking of a hybrid vehicle including a first motor mounted on an engine side and a second motor mounted on a transmission side, includes: collecting, by a controller, driving information of the vehicle during an operation of the vehicle and starting braking when a brake pedal operation signal is input; determining, by the controller, each of a first regenerative braking capacity using only a second motor P2 and a second regenerative braking capacity using a first motor P1 and the second motor P2 in consideration of whether an engine clutch is engaged collected as the driving information, battery chargeable power, potential generation power of each of the first motor P1 and the second motor P2 based on the engine clutch, and engine friction force; and determining, by the controller, whether to maintain engagement of the engine clutch by determining whether an regenerative braking capacity at the time of disengagement of the engine clutch determined in a state in which the engine clutch is engaged is less than a first reference value α, wherein the engagement of the engine clutch is maintained when the regenerative braking capacity at the time of disengagement of the engine clutch is less than the first reference value α.

In some exemplary embodiments of the present disclosure, the method may further include: when the regenerative braking capacity at the time of disengagement of the engine clutch is greater than the first reference value, disengaging the engine clutch and controlling sole regenerative braking using only the second motor P2.

In some exemplary embodiments of the present disclosure, the first regenerative braking capacity may be determined as a smaller value among a maximum power of the second motor and a product of the battery chargeable power and the battery charging efficiency, and the second regenerative braking capacity may be determined as a smaller value among a sum of a maximum power of the first motor, the maximum power of the second motor, and the engine friction force and a sum of the product of the battery chargeable power and the battery charging efficiency and the engine friction force.

In some exemplary embodiments of the present disclosure, the method may further include: determining whether a deviation obtained by subtracting a regenerative braking amount from an available regenerative braking torque at the time of disengagement of the engine clutch is less than a second reference value γ; and determining whether a maximum braking amount arrival time from a starting time point of braking is less than a third reference value β, wherein, when the deviation is less than the second reference value γ and the maximum braking amount arrival time t1 is less than the third reference value β, the engagement of the engine clutch may be maintained.

In some exemplary embodiments of the present disclosure, when the deviation is greater than or equal to the second reference value γ or the maximum braking amount arrival time t1 is greater than or equal to the third reference value β, the determining of whether to maintain engagement of the engine clutch may be performed again.

In some exemplary embodiments of the present disclosure, the method may further include: after maintaining the engagement of the engine clutch, determining a regenerative braking amount according to cooperative regenerative braking control using the first motor P1 and the second motor P2; and preferentially determining a first motor regenerative braking amount and determining a second motor regenerative braking amount by subtracting the first motor regenerative braking amount from the regenerative braking amount.

In some exemplary embodiments of the present disclosure, the method may further include: after determining the second motor regenerative braking amount, determining, by the controller, whether a deviation value obtained by subtracting the regenerative braking amount from the regenerative braking capacity at the time of disengagement of the engine clutch is greater than 0 and less than a fourth reference value ζ; and when reference time t2 in a state satisfying a condition of the deviation value is more than a fifth reference value η, disengaging, by the controller, the engine clutch.

In some exemplary embodiments of the present disclosure, the method may further include: determining a regenerative braking amount in a sole regenerative braking situation using only the second motor P2 with the engine clutch disengaged; and determining a second motor regenerative braking amount to the same value as a regenerative braking demand.

In some exemplary embodiments of the present disclosure, the method may further include: after determining the second motor regenerative braking amount, engaging, by the controller, the engine clutch when the regenerative braking capacity at the time of disengagement of the engine clutch is less than a sixth reference value δ and a total braking amount exceeds a seventh reference value E.

In some exemplary embodiments of the present disclosure, the method may further include: after determining the second motor regenerative braking amount, maintaining the disengaged state of the engine clutch when the regenerative braking capacity is greater than or equal to the sixth reference value δ or the total braking amount is less than the seventh reference value δ at the time of disengagement of the engine clutch.

According to another exemplary embodiment of the present disclosure, a regenerative braking system of a hybrid vehicle includes: an engine configured to generate power necessary for driving a vehicle by burning fuel; a first motor mounted on a first driveshaft on an engine side and operating as an electric motor or a generator; a second motor mounted on a second driveshaft on a transmission side and generating power necessary for driving the vehicle; an engine clutch mounted between the first motor on the engine side and the second motor on the transmission side and configured to engage or disengage the first and second driveshafts from each other; a battery configured to provide power to the first power and the second motor P2 or charge electrical energy generated by the first motor and the second motor; and a controller configured to preferentially control sole regenerative braking using the second motor according to a regenerative braking demand when controlling braking of the vehicle and perform cooperative regenerative braking control using the first motor and the second motor through engagement of the engine clutch determined in consideration of loss due to engine friction force when a regenerative braking demand exceeding an regenerative braking capacity of the second motor occurs.

In some exemplary embodiments of the present disclosure, the controller may be configured to determine each of a first regenerative braking capacity using only a second motor P2 and a second regenerative braking capacity using a first motor P1 and the second motor P2 in consideration of whether an engine clutch is engaged collected as driving information of the vehicle during regenerative braking, battery chargeable power, potential generation power of each of the first motor P1 and the second motor P2, and engine friction force.

In some exemplary embodiments of the present disclosure, the controller may maintain engagement of the engine clutch when an regenerative braking capacity at the time of disengagement of the engine clutch determined in a state in which the engine clutch is engaged is less than a first reference value α, and disengage the engine clutch when the regenerative braking capacity at the time of disengagement of the engine clutch is greater than or equal to the first reference value α.

In some exemplary embodiments of the present disclosure, the controller may engage the engine clutch when the regenerative braking capacity at the time of disengagement of the engine clutch is less than a sixth reference value δ and a total braking amount exceeds a seventh reference value δ, and maintain the disengaged state of the engine clutch when the regenerative braking capacity at the time of disengagement of the engine clutch is greater than or equal to the sixth reference value δ or the total braking amount is less than or equal to the seventh reference value ε.

According to an exemplary embodiment of the present disclosure, in the case of using the first motor P1 in the dual motor hybrid vehicle in which the first motor P1 and the second motor P2 are mounted on the engine side in front of the engine clutch and the transmission side behind the engine clutch, optimized cooperative regenerative braking control considering friction loss of the engine may be provided, securing vehicle performance and fuel efficiency.

Furthermore, the productivity of the hybrid vehicle provided with dual motors may be improved by providing regenerative braking control logic through engagement/disengagement of the engine clutch at an optimized time by considering various conditions considering a driver's braking situation and braking efficiency of each motor.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 schematically illustrates a configuration of a regenerative braking system for a hybrid vehicle provided with dual motors P1 and P2 according to an exemplary embodiment of the present disclosure.

FIG. 2 and FIG. 3 are flowcharts illustrating a method of controlling regenerative braking of a hybrid vehicle according to an exemplary embodiment of the present disclosure.

FIG. 4 illustrates cooperative regenerative braking control using the first motor P1 and the second motor P2 in an engine clutch engaged (ON) state according to an exemplary embodiment of the present disclosure.

FIG. 5 illustrates sole regenerative braking control using only the second motor P2 in the engine clutch disengaged (OFF) state according to an exemplary embodiment of the present disclosure.

FIG. 6 schematically illustrates a regenerative braking structure of the related art hybrid vehicle.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments will be described in detail with reference to the accompanying tables and drawings so that they may be easily practiced by those skilled in the art to which the present disclosure pertains.

The terminology used herein is for describing specific exemplary embodiments only and is not intended to limit the present disclosure. As used herein, the singular forms are intended to include the plural forms as well, unless the context clearly indicates otherwise. The terms “comprise” and/or “comprising”, when used herein, specify the presence of recited features, integers, levels, operations, components and/or components, but It will also be understood that does not exclude the presence or addition of one or more of the features, integers, levels, acts, elements, components and/or groups thereof.

As used herein, the term “and/or” includes any one or all combinations of the associated listed items.

Throughout the specification, terms such as first, second, A, B, (a), (b), etc. may be used, but the components should not be limited by these terms. Such terms are used for merely discriminating the corresponding elements from other elements and the corresponding elements are not limited in their essence, sequence, or precedence by the terms.

Throughout the specification, it will be understood that when an element is referred to as being “connected or coupled” to another element, it may be directly connected or coupled to the other element or intervening elements may be present therebetween. In contrast, when an element is referred to as being “directly connected or coupled” to another element, there are no intervening elements present.

Throughout the specification, the terms used in the present specification are merely used to describe particular exemplary embodiments and are not intended to limit the present disclosure. An expression used in the singular encompasses the expression of the plural, unless it includes a clearly different meaning in the context.

Furthermore, it is understood that one or more of the methods below or aspects thereof may be executed by at least one controller. The term “controller” may refer to a hardware device that includes a memory and a processor. The memory is configured to store program instructions and the processor is specially programmed to execute the program instructions to perform one or more processes described in more detail below. The controller as described herein, may be configured for controlling the operation of units, modules, components, devices, or the like. It is also understood that the methods below may be practiced by an apparatus that includes a controller along with one or more other components, as recognized by a person skilled in the art.

Hereinafter, a method of controlling regenerative braking of a hybrid vehicle provided with dual motors and a system thereof according to an exemplary embodiment of the present disclosure are described in detail with reference to the drawings.

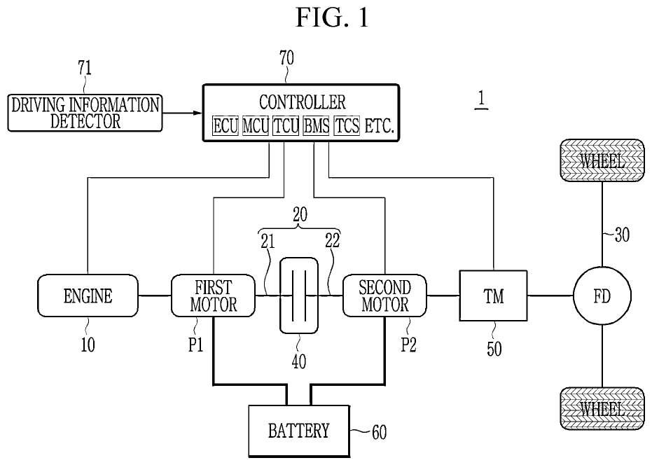

FIG. 1 schematically illustrates a configuration of a regenerative braking system for a hybrid vehicle provided with dual motors P1 and P2 according to an exemplary embodiment of the present disclosure.

Referring to FIG. 1, a regenerative braking system 1 of a hybrid vehicle according to an exemplary embodiment of the present disclosure includes an engine 10, a driveshaft 20, a first motor P1, a second motor P2, an engine clutch 40, a transmission 50, a battery 60, and a controller 70.

Hereinafter, throughout the specification, unless otherwise stated, the vehicle refers to a hybrid vehicle (HEV/PHEV) including a TMED II structure in which the first motor P1 and the second motor P2 are mounted on the front and rear of the engine clutch 40 (i.e., the engine side and the transmission side).

The engine 10 generates power necessary for driving the vehicle through combustion of fuel.

The first motor P1 is mounted on a first driveshaft 21 on the engine side and operates as an electric motor or a generator (hybrid starter generator (HSG)). That is, the first motor P1 may selectively operate as a generator.

The first motor P1 operates as an electric motor according to a control signal to start the engine 10, and while the ignition of the engine 10 is maintained, the first motor P1 selectively operates as a generator to generate electrical energy. Electrical energy generated by the first motor P1 may be charged to the battery 60. That is, the first motor P1 may operate as a generator during regenerative braking and supply regenerative energy to the battery 60.

The second motor P2 is mounted on the second driveshaft 22 on the transmission side, operates as a drive motor that generates power necessary for driving the vehicle, and assists power of the engine 10 when necessary. Furthermore, the second motor P2 operates as a generator during coasting drive or regenerative braking, and the electrical energy generated by the second motor P2 may be supplied to the battery 60. The first motor P1 and the second motor P2 may include a plurality of power switching elements and may include an inverter that converts a direct current (DC) voltage supplied from the battery 60 into a three-phase alternating current (AC) voltage.

The engine clutch 40 is provided between the engine 10 and the second motor P2 to connect or block power to each other. That is, power output from the engine 10 and the second motor P2 is transmitted to the drive wheel 30 provided at the rearmost of the driveshaft 20 through engagement of the engine clutch 40 via a differential FD.

The engine clutch 40 applied to the TMED II structure according to an exemplary embodiment of the present disclosure may be provided between a first driveshaft 21 to which the engine 10 and the first motor P1 are connected and a second driveshaft 22 to which the second motor P2 and the transmission 50 are connected to engage (ON) or disengage (OFF) the driveshaft 20 each other. Depending on whether the engine clutch 40 is engaged, the hybrid vehicle runs in a hybrid electric vehicle (HEV) mode or an electric vehicle (EV) mode.

The transmission 50 includes a shift gear built therein and changes power output from the engine 10 and the second motor P2 according to a shift gear stage. The transmission 50 may be implemented as an automatic transmission (AT/DCT) or a continuously variable transmission.

The battery 60 may be a high-voltage battery including a plurality of unit cells and may supply power to the first motor P1 or the second motor P2 or may be charged with electrical energy generated by the first and second motors P1 and P2. For example, the battery 60 may store high voltage power of DC 260V to 450V.

The controller 70 is configured to control the overall operation of the regenerative braking system 1 of a hybrid vehicle, that is, for dedicated cooperative regenerative braking control of a hybrid vehicle including a TMED II structure according to an exemplary embodiment of the present disclosure.

For example, the controller 70 may include at least one of various controllers, such as an electronic control unit (ECU), a motor control unit (MCU), a transmission control unit (TCU), a battery management system (BMS), a traction control system (TCS), and an active hydraulic booster (AHB) that is configured to control each of the engine 10, the first motor P1, the second motor P2, the engine clutch 40, the transmission 50, and the battery 60, which are the components of the HEV, or may be configured as a higher-level hybrid control unit (HCU) that is integrally configured to control for interconnection.

The controller 70 includes a driving information detector 71 that collects various driving information required for TMED II structure-specific regenerative braking control from various sensors and various lower-level controllers when the vehicle operates.

The driving information detector 71 is configured as an interface to detect real-time driving information including the driver's high-speed starting mode input during an operation of the vehicle, an engine operating status (an engine speed, an engine torque, etc.), a vehicle speed, an accelerator pedal signal (APS), a brake pedal signal (BPS), a wheel speed, a shift gear, an operating status of the first and second motors, an engine clutch status (engagement of the engine clutch and/or disengagement of the engine clutch), a road slope, shifting information, etc and transmit the real-time information to the controller 70.

The driving information detector 71 may include an engine speed sensor for detecting the engine speed, a engine torque sensor for detecting the engine torque, a vehicle speed sensor for detecting the vehicle speed, an accelerator pedal sensor for detecting the accelerator pedal signal and the driver's high-speed starting mode input, a brake pedal sensor for detecting the brake pedal signal, a wheel speed sensor for detecting the wheel speed, and a gyro sensor for detecting the road slope. The driving information detector 71 may communicate with a transmission and detect the shift gear and the shifting information. The driving information detector 17 may communicate with the first and second motors and detect the operating status of the first and second motors. And the driving information detector 17 may communicate with the engine clutch and detect the clutch status.

Furthermore, the driving information may further include various state data used in vehicle regenerative control, such as torque which may be generated by the first and second motors, battery chargeable power, a regeneration prohibition request signal (e.g., lift foot up (LFU), grade, sports mode, etc.) during shifting, engine friction force, and a regenerative braking demand determined according to distribution of braking force in a total braking amount requested according to a BPS signal.

The related art regenerative braking control assisted hydraulic (frictional) braking amount through regenerative braking using only the second motor P2 with respect to the total braking amount required for the vehicle. Meanwhile, the cooperative regenerative braking control dedicated for hybrid vehicle including the TMED II structure according to an exemplary embodiment of the present disclosure enables optimization of regenerative braking through cooperative control of the first motor P1 and the second motor P2.

The controller 70 according to an exemplary embodiment of the present disclosure may preferentially perform sole regenerative braking using only the second motor P2 according to the regenerative braking demand when controlling the braking of a Hybrid vehicle including the TMED II structure. However, when a regenerative braking demand exceeding a regenerative braking capacity of the second motor P2 occurs, the engine clutch 40 is engaged in consideration of loss due to engine friction force and cooperative regenerative braking control using the first motor P1 and the second motor P2 may be performed. Through this, vehicle performance and fuel efficiency may be secured. Here, the reason why sole regenerative braking using the second motor P2 is preferentially used is because the second motor P2 connected to an input shaft of the transmission 50 is more efficient than the first motor P1 connected to the engine 10.

The controller 70 is configured to determine the required total braking amount according to a brake pedal operation signal (BPS ON) during the operation of the vehicle and the regenerative braking demand determined by the distribution of braking force with hydraulic (friction) braking in the total braking amount. Furthermore, the controller 70 is configured to determine the regenerative braking capacity considering potential generation power of each of the first motor P1 and the second motor P2 during regenerative braking.

The controller 70 may be configured to determine each of a regenerative braking capacity (hereinafter, referred to as a “first regenerative braking capacity”) using only the second motor P2 in a state in which the engine clutch 40 is disengaged in consideration of whether the engine clutch 40 is engaged during regenerative braking, a current battery chargeable power, and the potential generation power of the first and second motors P1 and P2 and a “second regenerative braking capacity” using both the first motor P1 and the second motor P2 in a state in which the engine clutch 40 is engaged. Here, the controller 70 may be configured to determine the first and second regenerative braking capacities by further considering the battery chargeable power collected from a battery management system (BMS). Furthermore, the second regenerative braking capacity may be determined by considering loss due to engine friction force (EFF) collected by the ECU when the first motor P1 is used.

A method of determining the second regenerative braking capacity which may be output through cooperative regenerative braking control of the first motor P1 and the second motor P2 while the engine clutch 40 is engaged is described.

The second regenerative braking capacity determined while the engine clutch 20 is engaged may be determined as a smaller value among the sum (P1_max+P2_max+PS) of a first motor maximum power P1_max, a second motor maximum power P2_max, and power loss (PS) determined according to the engine friction force (EFF) and the sum of a value obtained by multiplying the battery chargeable power and a battery charging efficiency and the power loss (PS) determined according to the engine friction force (EFF). The power loss (PS) according to the engine friction force (EFF) may be determined based on a map data stored in the controller 70.

That is, the second regenerative braking capacity may be determined through Equation 1 below.

$$Second regenerative braking capacity = \qquad [ Equation 1 ]$$

$$Min ( first motor maximum power P1\_max +$$

$$second motor maximum power P2\_max +$$

$$loss power PS according to engine friction force ,$$

$$battery chargeable power * battery charging efficiency +$$

$$loss power PS according to engine friction force )$$

Here, the first motor maximum power P1_max may be determined as the product of maximum torque of the first motor P1 and a motor speed of the first motor. The second motor maximum power P2_max may be determined as the product of maximum torque of the second motor P2 and a motor speed of the second motor P2.

A method of determining the first regenerative braking capacity that enables regenerative braking by the second motor P2 alone in a state in which the engine clutch is disengaged is described.

The first regenerative braking capacity determined when the engine clutch 40 is disengaged may be determined as a smaller value among the second motor maximum power P2_max and the product of the battery chargeable power and the battery charging efficiency. The battery chargeable power may be determined from a SOC (state of charge) of the battery, and the battery charging efficiency may be determined from a SOH (state of health) of the battery.

That is, the first regenerative braking capacity may be determined through Equation 2 below.

$$First regenerative braking capacity = \qquad [ Equation 2 ]$$

$$Min ( second motor maximum power P2\_max , \\ battery chargeable power * battery charging efficiency )$$

Here, the second motor maximum power P2_max may be determined as the product of maximum torque of the second motor P2 and a motor speed of the second motor P2.

The controller 70 may engage (including maintaining engagement of the engine clutch) or disengage the engine clutch 40 using the regenerative braking demand and the determined regenerative braking capacity.

Whether regenerative braking of the first motor P1 is performed may be determined depending on whether the engine clutch 40 is engaged. That is, when the engine clutch 40 is engaged, regenerative braking by the first motor P1 is used. Furthermore, when the engine clutch 40 is disengaged, regenerative braking by the first motor P1 is not used.

For example, the controller 70 may compare the regenerative braking demand with the first regenerative braking capacity and/or the second regenerative braking capacity, and if cooperative regenerative braking control using the first motor P1 is necessary, the controller 70 may engage the engine clutch 40 or maintain the engaged state of the engine clutch 40. On the other hand, the controller 70 may compare the regenerative braking demand with the first regenerative braking capacity and/or the second regenerative braking capacity, and if the regenerative braking demand may be satisfied only with the second motor P2, the controller 70 may disengage the engine clutch 40.

Furthermore, the controller 70 may be configured for controlling each of a motor torque output of the first motor P1 and a motor torque output of the second motor P2 to execute cooperative regenerative braking control through the MCU. The controller 70 may perform control to maintain the engaged state of the engine clutch 40 for use of the first motor P1 during the cooperative regenerative braking control.

Furthermore, in terms of shift control, the related art regenerative braking method was performed when the engine clutch was disengaged, so regenerative braking using only the second motor P2 in EV mode was necessary. In contrast, when the controller 70 of the present disclosure performs cooperative regenerative braking control by use of the first motor P1 in addition to the second motor P2, since the engine clutch 40 is engaged, cooperative shifting control according to a change in inertia may be performed.

The controller 70 may be implemented with one or more processors that operate according to a set program, and the set program may be programmed to perform each operation of the method of controlling regenerative braking of a hybrid vehicle according to an exemplary embodiment of the present disclosure.

The method of controlling regenerative braking of a hybrid vehicle is described with reference to the drawings below, through which the description of the controller 70 may be further detailed.

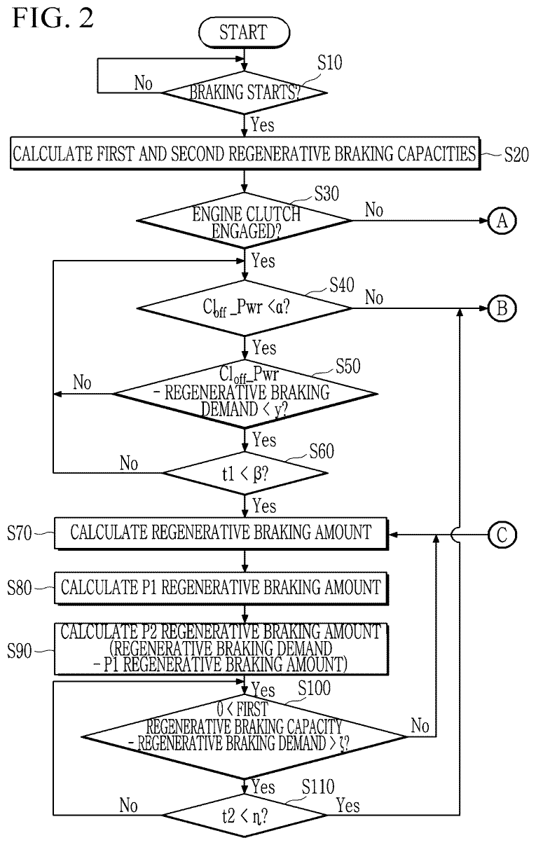

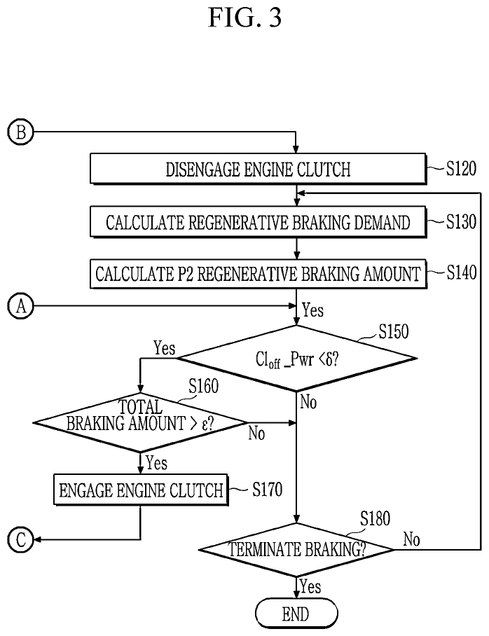

FIG. 2 and FIG. 3 are flowcharts illustrating a method of controlling regenerative braking of a hybrid vehicle according to an exemplary embodiment of the present disclosure.

Referring to FIG. 2 and FIG. 3, the method of controlling regenerative braking of a hybrid vehicle according to an exemplary embodiment of the present disclosure is described based on the assumption of a scenario in which a driver puts on the brake while driving a hybrid vehicle.

While driving the hybrid vehicle, the controller 70 collects real-time driving information to monitor the driver's brake pedal operation (BPS) signal (S10), and start braking when the BPS signal is input (S10; Yes).

Here, the controller 70 may collect real-time driving information, such as the regenerative braking demand determined according to the distribution of braking force with inflow braking in a total braking amount according to the BPS signal, potential generation power of the first and second motors P1 and P2, the battery chargeable power, and engine friction force (EFF). Furthermore, the controller 70 is preferentially configured to control regenerative braking of the second motor P2 according to the regenerative braking demand, and when the regenerative braking demand exceeds the regenerative braking capacity of the second motor P2, the controller 70 may perform cooperative regenerative braking control additionally using the first motor P1 by engaging the engine clutch 40.

The controller 70 is configured to determine each of a first regenerative braking capacity using only the second motor P2 (a regenerative braking capacity when the engine clutch is disengaged) and a second regenerative braking capacity using the first motor P1 and the second motor P2 (a regenerative braking capacity when the engine clutch is engaged) in consideration of whether the engine clutch 40 is engaged, battery chargeable power, potential generation power of the first and second motors P1 and P2, and loss power according to engine friction force (EFF) collected by the driving information detector 71 (S20).

The controller 70 is configured to determine whether the engine clutch 40 is engaged (S30), and if the engine clutch 40 is engaged (S30; Yes), the controller 70 is configured to perform cooperative regenerative braking control using the first motor P1 and the second motor P2. Meanwhile, when the engine clutch 40 is disengaged (S30; No), the controller 70 is configured to perform regenerative braking control using only the second motor P2 preferentially.

Hereinafter, the method of controlling regenerative braking of a hybrid vehicle according to an exemplary embodiment of the present disclosure is described by distinguishing between a state in which the engine clutch is engaged and a state in which the engine clutch is disengaged.

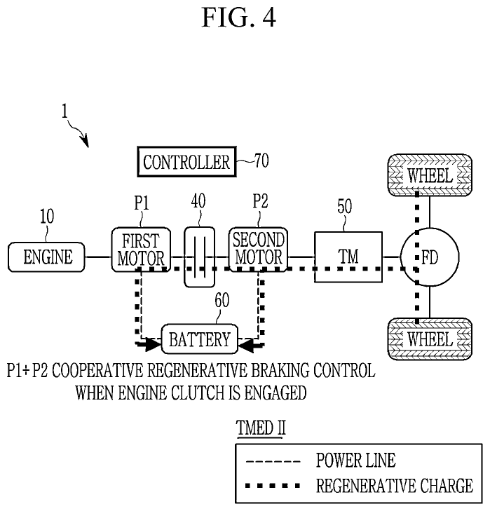

FIG. 4 illustrates cooperative regenerative braking control using the first motor P1 and the second motor P2 in the engine clutch engaged (ON) state according to an exemplary embodiment of the present disclosure.

Generally, regenerative braking was performed only by the second motor P2 when the engine clutch was engaged. Meanwhile, referring to FIG. 4, in an exemplary embodiment of the present disclosure, cooperative regenerative braking control is performed using the first motor P1 and the second motor P2. To use regenerative braking of the first motor P1, the engine 10 should be in a driving state and the engine clutch 40 should be engaged. In the present situation, loss due to engine friction force (EFF) is inevitable, and in some cases, only unnecessary loss may occur. Furthermore, since the efficiency of the first motor P1 is worse than that of the second motor P2, cooperative control logic considering the efficiency of the first and second motors P1 and P2 when the engine clutch 40 is engaged is necessary. Therefore, in a situation in which the engine clutch 40 is engaged and the first motor P1 is used, it is important to determine whether to maintain engagement of the engine clutch 40 or whether to disengage the engine clutch 40 by considering loss due to engine friction force (EFF) and regenerative braking efficiency.

Accordingly, in a cooperative regenerative braking control situation using the first motor P1 and the second motor P2 in which the engine clutch 40 of FIG. 4 is engaged, the controller 70 is configured to determine the driver's braking situation in consideration of various conditions and determine whether to maintain the engaged state of the engine clutch 40 (see FIG. 4).

The controller 70 is configured to determine whether the regenerative braking capacity Cl_{off}_Pwr at the time of disengagement of the engine clutch is less than a first reference value α, and is configured to determine whether to maintain engagement of the engine clutch 40 (S40).

If the regenerative braking capacity at the time of disengagement of the engine clutch is less than the first reference value α, the regenerative braking demand cannot be satisfied with only the second motor P2, so that the regenerative braking demand may be satisfied through cooperative control of the first motor P1 and the second motor P2.

The first reference value α may be determined based on a vehicle speed. The first reference value α is based on the vehicle's braking situation being a medium braking situation (for example, the opening amount of a brake pedal is between 40% and 50%), and the first reference value α in the medium braking situation may be determined from the torque of is 500 Nm of a reference torque in the medium braking situation.

In operation S40, if the regenerative braking capacity Cl_{off}_Pwr at the time of disengagement of the engine clutch is greater than or equal to the first reference value α (S40; No), the controller 70 maintains the engagement of the engine clutch 40.

In operation S40, if the regenerative braking capacity Cl_{off}_Pwr at the time of disengagement of the engine clutch less than the first reference value α (S40; Yes), the controller 70 disengages the engine clutch 40 and is configured to perform sole regenerative braking using only the second motor P2.

Furthermore, the controller 70 is configured to determine whether a deviation obtained by subtracting the regenerative braking demand from the regenerative braking capacity Cl_{off}_Pwr at the time of disengagement of the engine clutch is less than a second reference value γ (S50).

If the deviation obtained by subtracting the regenerative braking demand from the regenerative braking capacity at the time of disengagement of the engine clutch is less than the second reference value γ, the regenerative braking demand cannot be satisfied only with the second motor P2, so that the controller 70 maintains engagement of the engine clutch 40.

Here, the second reference value γ may be determined to be approximately 10% of the first reference value α. For example, the second reference value γ may be determined from the torque of 50 Nm (10% of the first reference value (500 Nm)).

In operation S50, if the deviation obtained by subtracting the regenerative braking demand from the regenerative braking capacity Cl_{off}_Pwr at the time of disengagement of the engine clutch is greater than or equal to the second reference value γ (S50; No), the controller 70 may return to operation S40 and determine again whether to maintain engagement of the clutch 40.

Meanwhile, in operation S50, if the deviation obtained by subtracting the regenerative braking demand from the regenerative braking capacity Cl_{off}_Pwr at the time of disengagement of the engine clutch is less than the second reference value γ (S50; Yes), the controller 70 is configured to determine whether a maximum braking amount arrival time t1 from a starting time point of braking is less than a third reference value β (S60). Here, the third reference value β is used to determine the driver's willingness to brake suddenly and may be set, for example, to 1 to 1.5 seconds during which the driver reaches the maximum braking amount (for example, the opening amount of the brake pedal is 90% or more) after starting braking normally.

In operation S60, if the maximum braking amount arrival time t1 from the starting time point of braking is more than the third reference value β (S60; No), the controller 70 may return to operation S40 and determine again whether to maintain engagement of the engine clutch.

Meanwhile, in operation S60, if the maximum braking amount arrival time t1 from the driver's start of braking is less than the third reference value β (S60; Yes), the controller 70 may finally maintain engagement of the engine clutch 40.

The controller 70 is configured to determine the regenerative braking amount according to the cooperative regenerative braking control (P1+P2) when the engine clutch is engaged (S70). The regenerative braking amount according to the cooperative regenerative braking control may be determined by adding up a value obtained by multiplying the regenerative braking amount of the first motor P1 by the efficiency of the first motor P1 and a value obtained by multiplying the regenerative braking amount of the second motor P2 by the efficiency of the second motor P2.

The controller 70 preferentially is configured to determine the regenerative braking amount of the first motor P1 (S80) and is configured to determine the regenerative braking amount of the second motor P2 by subtracting the regenerative braking amount of the first motor P1 from the regenerative braking demand (S90).

The controller 70 may be configured to determine the regenerative braking amount of the first motor P1 and the regenerative braking amount of the second motor P2 by considering the efficiency of the first motor P1 and the second motor P2.

Here, the controller 70 may first determine the regenerative braking amount of the first motor P1, which is the maximum regenerative braking amount, and then determine the regenerative braking amount of the second motor P2. Since the efficiency of the first motor P1 is worse than that of the second motor P2, the controller 70 may preferentially determine the regenerative braking amount of the first motor P1 and then determine the regenerative braking amount of the second motor P2.

For example, the regenerative braking amount according to a motor efficiency map may be pre-stored in the controller 70, and the controller 70 may be configured to determine the maximum regenerative braking amount of the first motor according to the motor efficiency map.

Also, the controller 70 may be configured to determine the regenerative braking amount by adding up a value obtained by multiplying the regenerative braking amount of the first motor by the motor efficiency of the first motor and a value obtained by subtracting the regenerative braking amount of the first motor from the total braking amount and then multiplied by the efficiency of the second motor. That is, the regenerative braking amount according to the cooperative regenerative braking control of the first motor P1 and the second motor P2 may be determined through Equation 3 below.

$$Regenerative braking amount = \qquad [ Equation 3 ]$$

$$( Regenerative braking amount of first motor * efficiency of first motor ) +$$

$$( Total braking amount - regenerative braking amount of first motor ) *$$

$$efficiency of second motor$$

Furthermore, the controller 70 is configured to determine a disengagement condition of the engine clutch 40 to minimize loss due to unnecessary engine friction force (EFF) during cooperative regenerative braking control (P1+P2) of the first motor P1 and the second motor P2. Here, if it is determined that sole regenerative braking using only the second motor P2 by disengaging the engine clutch 40 is advantageous, the controller 70 disengages the engine clutch 40.

For example, the controller 70 is configured to determine whether a deviation value obtained by subtracting the regenerative braking demand from the regenerative braking capacity (the first regenerative braking capacity) at the time of disengagement of the engine clutch 40 is greater than 0 and less than a fourth reference value ζ. (S100). Furthermore, it may be determined whether reference time t2 for maintaining the condition that the deviation value is greater than 0 and less than the fourth standard value ζ satisfies the fifth standard value η or more (S110).

Operations S100 and S110 are for determining whether to disengage the engine clutch 40 to minimize loss due to unnecessary engine friction force, and the fourth reference value ζ may be determined from the torque of 100 Nm.

In other words, the fact that the deviation value between the regenerative braking capacity P2 and the regenerative braking demand at the time of disengagement of the engine clutch is less than the fourth reference value ζ means that the regenerative braking capacity P2 at the time of disengagement of the engine clutch is sufficiently greater than the regenerative braking demand, and thus, in the instant case, the controller 70 disengages the engine clutch 40 and is configured to perform regenerative braking only with the second motor P2.

Also, a fifth reference value η is used to determine whether the regenerative braking demand does not increase rapidly, and the fifth reference value η may be determined to be about 1 second.

Here, if the determination condition of operation S100 is not satisfied (S100; No), the controller 70 returns to operation S70, and if the determination condition of operation S110 is not satisfied (S110; No), the controller 70 returns to operation S100 and repeats the previous description.

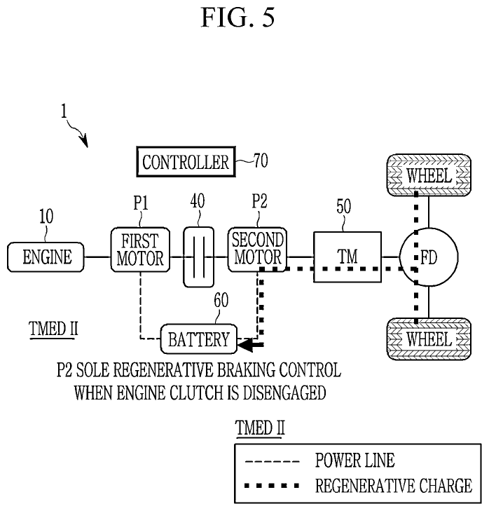

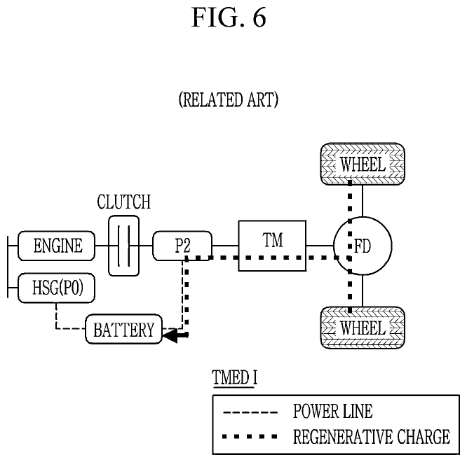

Meanwhile, if the reference time t2 for maintaining the state satisfying the condition of operation S100 (S100; yes) is less than the fifth reference value η (S110; yes), the controller 70 disengages the engine clutch 40 (S120) in FIG. 5.

Meanwhile, FIG. 5 illustrates sole regenerative braking control using only the second motor P2 in the disengaged (OFF) state of the engine clutch according to an exemplary embodiment of the present disclosure.

Referring to FIG. 5, since only the second motor P2 may be used when the engine clutch 40 is disengaged, the controller 70 is configured to perform sole regenerative braking control using only the second motor P2.

The controller 70 is configured to determine a regenerative braking demand determined by braking amount distribution from the total braking amount (S130), and is configured to determine the regenerative braking amount of the second motor to be the same as the regenerative braking demand (S140).

When a highly variable regenerative braking demand is input in a situation in which the engine clutch 40 is disengaged, the controller 70 induces engagement of the engine clutch 40 (that is, engages the engine clutch). Here, in operation S30, if the engine clutch 40 is in a disengaged state (S30; No), the controller 70 is configured to perform a process of determining whether to engage the engine clutch 40.

For example, the controller 70 is configured to determine the regenerative braking capacity Cl_{off}_Pwr at the time of disengagement of the engine clutch, to determine whether the regenerative braking capacity Cl_{off}_Pwr at the time of disengagement of the engine clutch is less than the sixth reference value δ (S150), and to determine whether the total braking amount exceeds a seventh reference value & (S160).

Here, the sixth reference value δ may be determined from 800 Nm of a reference torque in the high braking situation, which is a normal high braking situation, and the seventh reference value ε may be set at a level increased by 120% based on the sixth reference value δ.

Here, if the regenerative braking capacity Cl_{off}_Pwr at the time of disengagement of the engine clutch is less than the sixth reference value δ (S150; Yes) and the total braking amount exceeds the seventh reference value & increased from the sixth reference value δ (S160; Yes), the controller 70 engages the engine clutch 40 (S170). Here, the controller 70 returns to operation S70 according to engagement (ON) of the engine clutch.

That is, when the regenerative braking capacity of the second motor is small and the total braking amount is large, the regenerative braking demand cannot be satisfied with only the second motor P2, so that the controller 70 may engage the engine clutch 40 and perform regenerative braking control through the first motor P1 and the second motor P2.

Meanwhile, if the regenerative braking capacity Cl_{off}_Pwr at the time of disengagement of the engine clutch is greater than or equal to the sixth reference value δ (S150; No) or if the total braking amount is less than the seventh reference value ε (S160; No), the controller 70 maintains the disengaged state of the engine clutch 40.

Thereafter, the controller 70 returns to operation S130 and repeats the subsequent process until braking terminates according to release of a BPS signal (OFF) of the driver (S180). However, when termination of braking is confirmed (S180; Yes), the controller 70 terminates the regenerative braking control of the vehicle.

Accordingly, according to an exemplary embodiment of the present disclosure, in the hybrid vehicle including the structure in which the first motor P2 and the second motor P2 are mounted at the front (engine side) and rear (transmission side) with respect to the engine clutch, when the motor P1 is used, optimized cooperative regenerative braking control is provided in consideration of loss of engine friction force, securing vehicle performance and fuel efficiency.

Furthermore, the productivity of the hybrid vehicle provided with the dual motors may be improved by providing regenerative braking control logic through engagement/disengagement of the engine clutch at an optimized time by considering various conditions considering the driver's braking situation and the braking efficiency of each motor.

Also, the exemplary embodiments of the present disclosure may not necessarily be implemented only through the foregoing devices and/or methods but may also be implemented through a program for realizing functions corresponding to the configurations of the exemplary embodiments of the present disclosure, a recording medium including the program, or the like. Such an implementation may be easily conducted by a person skilled in the art to which the present disclosure pertains from the foregoing description of embodiments.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operably may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of controlling regenerative braking of a hybrid vehicle including a first motor mounted on an engine side and a second motor mounted on a transmission side, the method comprising:
collecting, by a controller, driving information of the vehicle during an operation of the vehicle and starting braking in response that a brake pedal operation signal is input;
determining, by the controller, each of a first regenerative braking capacity using only the second motor and a second regenerative braking capacity using the first motor and the second motor in consideration of whether an engine clutch mounted between the first motor and the second motor is engaged collected as the driving information, battery chargeable power, potential generation power of each of the first motor and the second motor based on the engine clutch, and engine friction force; and
determining, by the controller, whether to maintain engagement of the engine clutch by determining whether an regenerative braking capacity at a time of disengagement of the engine clutch determined in a state in which the engine clutch is engaged is less than a first reference value,
wherein the engagement of the engine clutch is maintained in response that the regenerative braking capacity at the time of disengagement of the engine clutch is less than the first reference value.

2. The method of claim 1, further including:
in response that the regenerative braking capacity at the time of disengagement of the engine clutch is greater than the first reference value, disengaging the engine clutch and controlling sole regenerative braking using only the second motor.

3. The method of claim 1,
wherein the first regenerative braking capacity is determined as a smaller value among a maximum power of the second motor and a product of the battery chargeable power and battery charging efficiency, and
wherein the second regenerative braking capacity is determined as a smaller value among a sum of a maximum power of the first motor, the maximum power of the second motor, and the engine friction force and a sum of the product of the battery chargeable power and the battery charging efficiency and the engine friction force.

4. The method of claim 1, further including:
determining whether a deviation obtained by subtracting a regenerative braking amount from an available regenerative braking torque at the time of disengagement of the engine clutch is less than a second reference value; and
determining whether a maximum braking amount arrival time from a starting time point of braking is less than a third reference value,
wherein, in response that the deviation is less than the second reference value and the maximum braking amount arrival time is less than the third reference value, the engagement of the engine clutch is maintained.

5. The method of claim 4, wherein
in response that the deviation is greater than or equal to the second reference value or the maximum braking amount arrival time is greater than or equal to the third reference value, the determining of whether to maintain the engagement of the engine clutch is performed again.

6. The method of claim 4, further including:
after maintaining the engagement of the engine clutch,
determining a regenerative braking amount according to cooperative regenerative braking control using the first motor and the second motor; and
determining a first motor regenerative braking amount and determining a second motor regenerative braking amount by subtracting the first motor regenerative braking amount from the regenerative braking amount determined according to the cooperative regenerative braking control.

7. The method of claim 6, further including:
after determining the second motor regenerative braking amount,
determining, by the controller, whether a deviation value obtained by subtracting the regenerative braking amount from the regenerative braking capacity at the time of disengagement of the engine clutch is greater than 0 and less than a fourth reference value; and
in response that a reference time in a state satisfying a condition of the deviation value is more than a fifth reference value, disengaging, by the controller, the engine clutch.

8. The method of claim 1, further including:
determining a regenerative braking amount in a sole regenerative braking situation using only the second motor with the engine clutch disengaged; and
determining a second motor regenerative braking amount to the same value as a regenerative braking demand.

9. The method of claim 8, further including:
after determining the second motor regenerative braking amount,
engaging, by the controller, the engine clutch in response that the regenerative braking capacity at the time of disengagement of the engine clutch is less than a sixth reference value and a total braking amount exceeds a seventh reference value.

10. The method of claim 9, further including:
after determining the second motor regenerative braking amount,
maintaining a disengaged state of the engine clutch in response that the regenerative braking capacity is greater than or equal to the sixth reference value or the total braking amount is less than the seventh reference value at the time of disengagement of the engine clutch.

11. A regenerative braking system of a hybrid vehicle, the regenerative braking system comprising:
an engine configured to generate power necessary for driving a vehicle by burning fuel;
a first motor mounted on a first driveshaft on an engine side and operating as an electric motor or a generator;
a second motor mounted on a second driveshaft on a transmission side and generating power necessary for driving the vehicle;
an engine clutch mounted between the first motor on the engine side and the second motor on the transmission side and configured to engage or disengage the first and second driveshafts from each other;
a battery configured to provide power to the first power and the second motor or charge electrical energy generated by the first motor and the second motor; and
a controller configured to control sole regenerative braking using the second motor according to a regenerative braking demand in controlling braking of the vehicle and perform cooperative regenerative braking control using the first motor and the second motor through engagement of the engine clutch determined in consideration of loss due to engine friction force in response that the regenerative braking demand exceeding an regenerative braking capacity of the second motor occurs.

12. The regenerative braking system of claim 11, wherein the controller is further configured to determine each of a first regenerative braking capacity using only the second motor and a second regenerative braking capacity using the first motor and the second motor in consideration of whether the engine clutch is engaged collected as driving information of the vehicle during regenerative braking, battery chargeable power, potential generation power of each of the first motor and the second motor based on the engine clutch, and the engine friction force.

13. The regenerative braking system of claim 12, wherein the controller is further configured to:
maintain engagement of the engine clutch in response that an regenerative braking capacity at a time of disengagement of the engine clutch determined in a state in which the engine clutch is engaged is less than a first reference value, and
disengage the engine clutch in response that the regenerative braking capacity at the time of disengagement of the engine clutch is greater than or equal to the first reference value.

14. The regenerative braking system of claim 12,
wherein the first regenerative braking capacity is determined as a smaller value among a maximum power of the second motor and a product of the battery chargeable power and battery charging efficiency, and
wherein the second regenerative braking capacity is determined as a smaller value among a sum of a maximum power of the first motor, the maximum power of the second motor, and the engine friction force and a sum of the product of the battery chargeable power and the battery charging efficiency and the engine friction force.

15. The regenerative braking system of claim 12, wherein the controller is further configured to:
determine whether a deviation obtained by subtracting a regenerative braking amount from an available regenerative braking torque at a time of disengagement of the engine clutch is less than a second reference value; and
determine whether a maximum braking amount arrival time from a starting time point of braking is less than a third reference value,
wherein, in response that the deviation is less than the second reference value and the maximum braking amount arrival time is less than the third reference value, the engagement of the engine clutch is maintained.

16. The regenerative braking system of claim 15, wherein, after maintaining the engagement of the engine clutch, the controller is further configured to:
determine a regenerative braking amount according to cooperative regenerative braking control using the first motor and the second motor; and
determine a first motor regenerative braking amount and determining a second motor regenerative braking amount by subtracting the first motor regenerative braking amount from the regenerative braking amount determined according to the cooperative regenerative braking control.

17. The regenerative braking system of claim 16, wherein
after determining the second motor regenerative braking amount, the controller is further configured to:
determine whether a deviation value obtained by subtracting the regenerative braking amount from a regenerative braking capacity at a time of disengagement of the engine clutch is greater than 0 and less than a fourth reference value; and
in response that a reference time in a state satisfying a condition of the deviation value is more than a fifth reference value, disengage the engine clutch.

18. The regenerative braking system of claim 12, wherein the controller is further configured to:
engage the engine clutch in response that a regenerative braking capacity at a time of disengagement of the engine clutch is less than a sixth reference value and a total braking amount exceeds a seventh reference value, and
maintain a disengaged state of the engine clutch in response that the regenerative braking capacity at the time of disengagement of the engine clutch is greater than or equal to the sixth reference value or the total braking amount is less than or equal to the seventh reference value.
